(19) United States
(12) Patent Application Publication
(10) Pub. No.: US 2026/0277132 A1
(43) Pub. Date: Sep. 17, 2026

(54) TONER STORAGE CONTAINER

(71) Applicant: KYOCERA Document Solutions Inc., Osaka (JP)

(72) Inventor: Riku MINAMOTO, Osaka (JP)

(73) Assignee: KYOCERA Document Solutions Inc., Osaka (JP)

(21) Appl. No.: 19/556,665

(22) Filed: Mar. 4, 2026

(30) Foreign Application Priority Data
Mar. 11, 2025 (JP) 2025-038531

(51) Int. Cl. G03G 15/08

(52) U.S. Cl. CPC G03G 15/0872; G03G 15/0886; G03G 2215/0668

(57) ABSTRACT

A toner storage container includes a container body and a cap member. The cap member includes a hook portion that takes a restricting posture or a non-restricting posture. The hook portion has a base part and an arm part. The arm part extends in a straight line along the axial direction from the base part, has a tip facing the protruding part along the axial direction in the restricting posture, and elastically deforms such that, in the non-restricting posture, the tip is retracted radially outward so as not to face the protruding part along the axial direction. The hook portion has an operation hole formed in it extending radially inward from its radially outer face.

### INCORPORATION BY REFERENCE

This application is based on and claims the benefit of priority from Japanese Patent Application No. 2025-038531 filed on Mar. 11, 2025, the contents of which are hereby incorporated by reference.

### BACKGROUND

The present disclosure relates to a toner storage container.

In image forming apparatuses employing an electrophotographic method, in an image development process, toner is fed from a developing unit to an electrostatic latent image formed on the surface of an image carrying member (e.g., a photosensitive drum). The toner is supplied from a toner storage container to the developing unit.

The toner storage container includes a container body and a cap member. The container body can store toner in it and is a tubular member that is elongate along the central axial direction. The container body is screw-shaped. The container body is supported so as to be rotatable about the central axis. As the container body rotates, toner in the container body is conveyed in the central axial direction along this screw shape.

The cap member is attached to the container body so as to cover an opening portion formed in the container body. The cap member keeps the opening portion of the container body closed when the toner storage container is not attached to the image forming apparatus (e.g., during transport, storage, or the like) to avoid the leakage of toner out of the container body. When the toner storage container is attached to the image forming apparatus, the capping member leaves the opening portion of the container body open such that the space inside the container body communicates with a toner supply port in the image forming apparatus.

The cap member like this has a hook portion. The outer circumferential surface of the container body has formed on it a flange (projection) that protrudes outward along the radial direction (the direction orthogonal to the radial direction). The hook portion engages with this flange. The hook portion and the flange constitute what is called a snap-fit mechanism. The cap member is attached to the container body by this snap-fit mechanism.

When detaching the cap member attached to the container body, an operator lifts the hook portion up to a position away from the flange to elastically deform it. In doing so, the operator inserts a stick-shaped member with a pointed tip (a nail of the operator, a tool such as a flat-blade screwdriver) in a gap between the outer circumferential edge of the hook portion and the container body. With this stick-shaped member, the operator elastically deforms the hook portion.

### SUMMARY

According to one aspect of the present disclosure, a toner storage container includes a container body and a cap member. The container body stores toner in it and has an opening portion formed at one end of it along an axial direction along its central axis. The container body is in a cylindrical shape. The cap member is attached to one end of the container body along the axial direction so as to cover the opening portion and is detachable in the axial direction with respect to the container body. The container body has a protruding part that protrudes radially outward with respect to the container body from the outer circumferential surface of the container body. The cap member has a hook portion that, with the cap member attached to the container body, is in a restricting posture in which the hook portion makes contact with the protruding part along the axial direction to restrict the movement of the cap member along the axial direction and that, by elastically deforming radially outward from the restricting posture, takes a non-restricting posture in which the hook portion does not restrict the movement of the cap member along the axial direction. The hook portion has a base part and an arm part. The arm part extends in a straight line along the axial direction from the base part, has a tip facing the protruding part along the axial direction in the restricting posture, and elastically deforms such that the tip is retracted radially outward so as not to face the protruding part along the axial direction in the non-restricting posture. The hook portion has an operation hole formed in it extending radially inward from a radially outer face of the hook portion.

### BRIEF DESCRIPTION OF THE DRAWINGS

FIG. 1 is a schematic diagram showing the configuration of an image forming apparatus according to one embodiment of the present disclosure.

FIG. 2 is an enlarged view around an image forming portion in FIG. 1.

FIG. 3 is a perspective view showing the configuration of a toner supply portion.

FIG. 4 is a sectional view of a downstream end part, along the axial direction, of a toner container in a state accommodated in a container accommodating portion, as cut along the axial direction.

FIG. 5 is a perspective view of the toner container according to the embodiment as viewed from upstream in the insertion direction.

FIG. 6 is an exploded perspective view of a downstream end part, in the insertion direction, of the toner container according to the embodiment.

FIG. 7 is a sectional view of a downstream end part, in the insertion direction, of the toner container according to the embodiment as cut along the axial direction.

FIG. 8 is a sectional view of the toner container, showing a state where a hook portion and a flange portion are engaged together.

FIG. 9 is an enlarged sectional view around the hook portion and the flange portion shown in FIG. 8.

FIG. 10 is a perspective view of the hook portion.

FIG. 11 is an enlarged sectional part view of a cap member, showing a state where the hook portion is in a non-restricting posture.

FIG. 12 is a perspective view of a modified example of the hook portion according to the embodiment.

FIG. 13 is a perspective view of another modified example of the hook portion according to the embodiment.

### DETAILED DESCRIPTION

Now, an embodiment of the present disclosure will be described with reference to the accompanying drawings. First, a description will be given of the overall configuration of an image forming apparatus 100 according to the embodiment of the present disclosure. After that, toner containers 4a to 4d (toner storage containers) according to the present disclosure will be described in detail.

### 1.1 Overall Configuration of Image Forming Apparatus 100

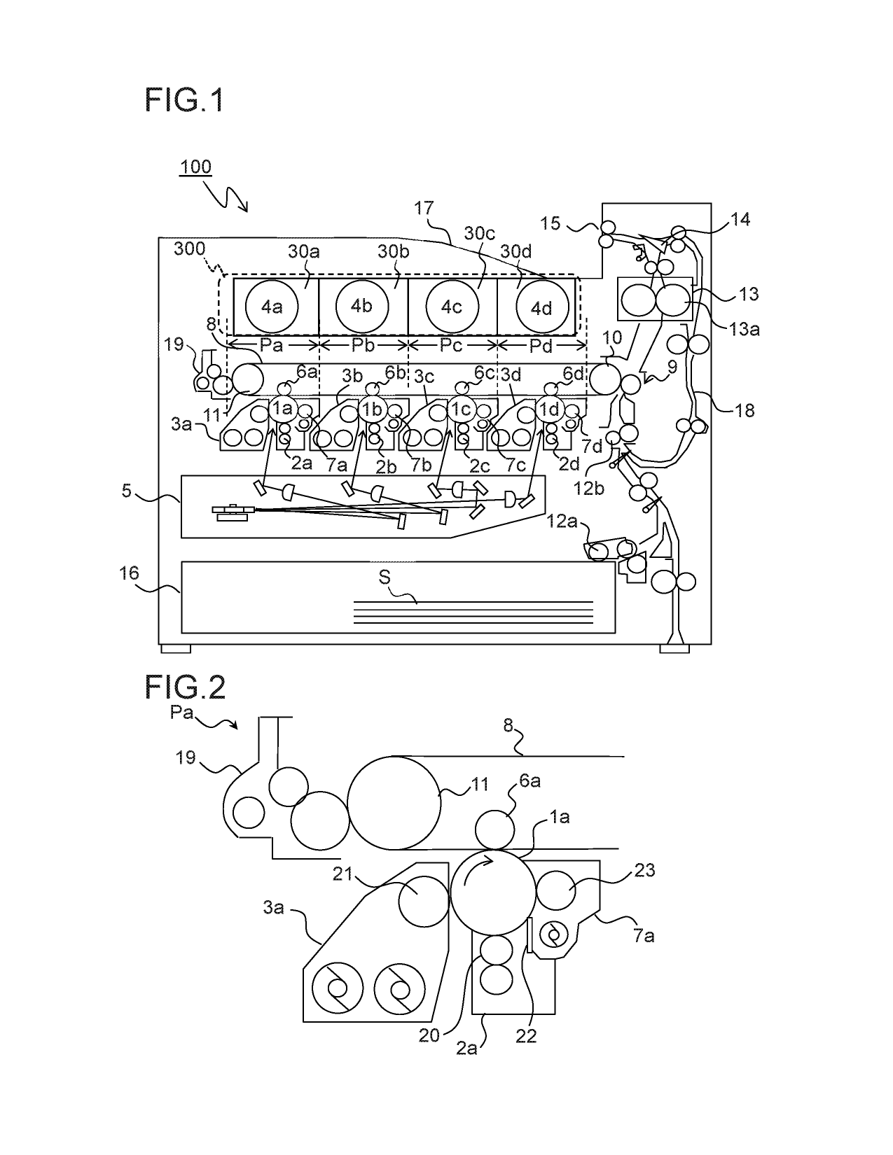

FIG. 1 is a schematic diagram showing the configuration of an image forming apparatus 100 according to one embodiment of the present disclosure. FIG. 2 is an enlarged view around an image forming portion Pa in FIG. 1.

The image forming apparatus 100 according to the present disclosure is what is called a tandem color printer. As shown in FIGS. 1 and 2, the image forming apparatus 100 includes image forming portions Pa to Pd, an intermediate transfer belt 8, a driving roller 10, a tension roller 11, a secondary transfer unit 9, an exposure device 5, a sheet cassette 16, a sheet feed roller 12a, a pair of registration rollers 12b, a fixing portion 13, a pair of discharge rollers 15, a belt cleaning unit 19, and a toner supply portion 300.

The image forming portions Pa to Pd are provided in this order from upstream along the conveyance direction (from left in FIG. 1). The image forming portions Pa to Pd are provided so as to correspond to images of different four colors (yellow, cyan, magenta, and black). The image forming portions Pa to Pd sequentially form a yellow, a cyan, a magenta, and a black image each through the processes of electrostatic charging, exposure to light, image development, and image transfer.

The image forming portions Pa to Pd have photosensitive drums 1a to 1d, respectively. Specifically, the image forming portion Pa includes the photosensitive drum 1a, the image forming portion Pb includes the photosensitive drum 1b, the image forming portion Pc includes the photosensitive drum 1c, and the image forming portion Pd includes the photosensitive drum 1d. The photosensitive drums 1a to 1d carry visible images (toner images) of different colors on their circumferential surfaces.

The intermediate transfer belt 8 is a seamless belt without a seam. The intermediate transfer belt 8 is provided adjacent to the photosensitive drums 1a to 1d. The intermediate transfer belt 8 is wound under a predetermined tension around the driving roller 10 and the tension roller 11 disposed substantially horizontally. The driving roller 10 and the tension roller 11 are in contact with the inner circumferential surface of the intermediate transfer belt 8. As the driving roller 10 rotates, the intermediate transfer belt 8 rotates.

The photosensitive drums 1a to 1d have toner images formed on their outer circumferential surfaces. The outer circumferential surfaces of the photosensitive drums 1a to 1d are in contact with the surface of the intermediate transfer belt 8. The photosensitive drums 1a to 1d primarily transfer the toner images formed on their outer circumferential surfaces sequentially to the intermediate transfer belt 8.

The exposure device 5 emits a light beam (laser light) to the surfaces of the photosensitive drums 1a to 1d. The exposure device 5 shines the light beam to the surfaces of the photosensitive drums 1a to 1d to form electrostatic latent images on the photosensitive drums 1a to 1d.

The sheet cassette 16 is provided in a lower part of the body of the image forming apparatus 100. The sheet cassette 16 stores a plurality of sheets S in it. The sheet feed roller 12a feeds a sheet S in the sheet cassette 16 to the pair of registration rollers 12b with predetermined timing. The pair of registration rollers 12b conveys the sheet S fed from the sheet feed roller 12a to the secondary transfer unit 9 with predetermined timing.

The secondary transfer unit 9 secondarily transfers the toner images primarily transferred to the intermediate transfer belt 8 to the sheet S and meanwhile conveys this sheet S to the fixing portion 13.

The fixing portion 13 has a pair of fixing rollers 13a. The pair of fixing rollers 13a heats and presses the sheet S conveyed to it to fix the toner images secondarily transferred to the sheet S. This forms a predetermined full-color image on the sheet S.

A branching portion 14 sorts the sheet S having passed through the fixing portion 13 toward the pair of discharge rollers 15 or toward a duplex conveyance passage 18. For example, when an image is formed once again on the back side of the sheet S, the branching portion 14 conveys the sheet S to the duplex conveyance passage 18. For another example, when no image is formed once again on the sheet S, the branching portion 14 conveys the sheet S to the pair of discharge rollers 15.

The pair of discharge rollers 15 discharges the sheet S conveyed from the fixing portion 13 out of the body of the image forming apparatus 100 (more specifically, onto a discharge tray 17 provided in the top face of the image forming apparatus 100).

The belt cleaning unit 19 faces the photosensitive drum 1a across the intermediate transfer belt 8 upstream of the rotation direction of the intermediate transfer belt 8. The belt cleaning unit 19 scrapes off (removes) the toner left on the surface of the intermediate transfer belt 8 after secondary transfer.

The toner supply portion 300 stores toner of different colors, namely yellow, cyan, magenta, and black. The toner supply portion 300 supplies toner to the image forming portions Pa to Pd (more specifically, to each of developing devices 3a to 3d, which will be described later) with predetermined timing.

### 1.2 Image Forming Portions Pa to Pd

As described above, the image forming portions Pa to Pd include the photosensitive drums 1a to 1d. In addition, the image forming portions Pa to Pd include primary transfer rollers 6a to 6d, charging devices 2a to 2d, developing devices 3a to 3d, and cleaning devices 7a to 7d. Note that the image forming portions Pa to Pd basically have a common configuration. Thus, here, the image forming portion Pa alone will be described. For the image forming portions Pb to Pd, the same reference signs are used and no overlapping description will be repeated.

The charging device 2a, the developing device 3a, and the cleaning device 7a are disposed around the photosensitive drum 1a along the drum rotation direction (along the clockwise direction in FIG. 2).

The primary transfer roller 6a is disposed so as to face the photosensitive drum 1a across the intermediate transfer belt 8. The primary transfer roller 6a produces a predetermined electric field between the primary transfer roller 6a and the photosensitive drum 1a.

The charging device 2a includes a charging roller 20 and the cleaning device 7a. The charging roller 20 is disposed so as to face the photosensitive drum 1a. The charging roller 20 electrostatically charges the surface of the photosensitive drum 1a uniformly.

The developing device 3a is loaded with a predetermined amount of toner. The developing device 3a includes a development roller 21. The development roller 21 is in contact with the photosensitive drum 1a and feeds toner to the development roller 21 and the photosensitive drum 1a.

The cleaning device 7a has a cleaning blade 22 and a rubbing roller 23. The cleaning blade 22 is disposed with its tip in contact with the photosensitive drum 1a. The cleaning blade 22 is located upstream of the charging roller 20 along the rotation direction of the photosensitive drum 1a. The rubbing roller 23 is a member in the form of a roller. The rubbing roller 23 is disposed with its outer circumferential surface in contact with the photosensitive drum 1a. The cleaning device 7a removes the toner left on the photosensitive drum 1a by using the cleaning blade 22 and the rubbing roller 23.

### 2. Image Formation Procedure

When a user feeds in an instruction to start image formation, first, a main motor (not shown) starts to rotate the photosensitive drums 1a to 1d. Then the charging rollers 20 electrostatically charge the surfaces of the photosensitive drums 1a to 1d uniformly. Next, the exposure device 5 forms electrostatic latent images according to an image signal on the photosensitive drums 1a to 1d.

In this state, the development rollers 21 feed toner onto the photosensitive drums 1a to 1d. This forms toner images according to the electrostatic latent images on the photosensitive drums 1a to 1d.

The primary transfer rollers 6a to 6d apply a predetermined transfer voltage between the primary transfer rollers 6a to 6d and the photosensitive drums 1a to 1d to produce electric fields between them. Then, the toner images of the different colors on the photosensitive drums 1a to 1d are primarily transferred to the intermediate transfer belt 8. These images of the four colors are formed in a predetermined positional relationship determined in advance so as to form a predetermined full-color image. After that, the toner left on the surfaces of the photosensitive drums 1a to 1d is removed by the cleaning devices 7a to 7d (more specifically, by the cleaning blade 22 and the rubbing roller 23).

### 3.1 TONER SUPPLY PORTION 300

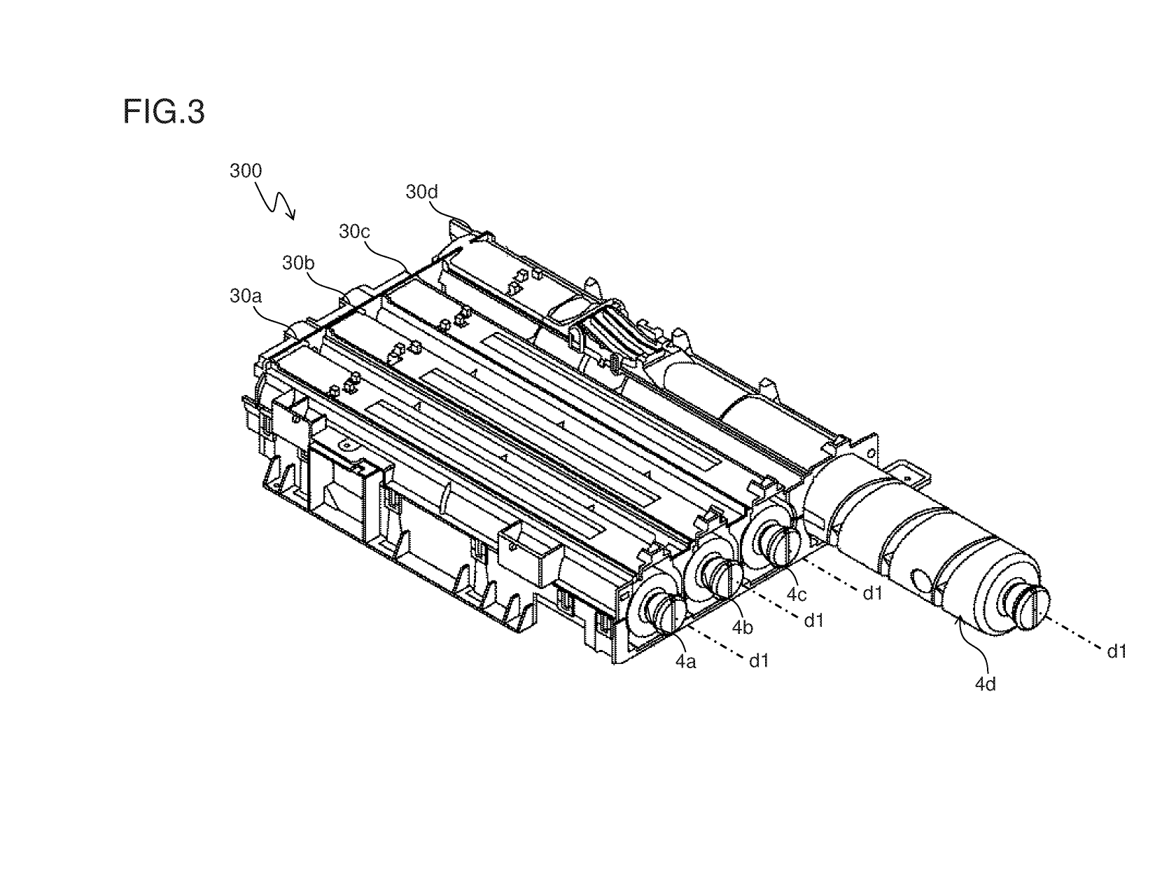

Next, the toner supply portion 300 will be described. FIG. 3 is a perspective view showing the configuration of the toner supply portion 300. As shown in FIG. 3, the toner supply portion 300 includes toner containers 4a to 4d and container accommodating portions 30a to 30d. Note that FIG. 3 illustrates a state where the toner container 4d alone is being accommodated into the container accommodating portion 30d and the toner containers 4a to 4c have already been accommodated in the container accommodating portions 30a to 30c.

The toner containers 4a to 4d are inserted into the container accommodating portions 30a to 30d along the direction of their central axes d1 (hereinafter, referred to also as the axial direction) from the front to the rear of the image forming portion 100 (from near right to far left in FIG. 3).

### 3.2 Container Accommodating Portions 30a to 30d

The container accommodating portions 30a to 30d are arrayed along the left-right direction (i.e., the direction orthogonal to both the insertion direction and the vertical direction, i.e., the left-right direction across the plane of FIG. 1). The container accommodating portions 30a to 30d are formed in the image forming apparatus 100 each as a tubular space that extends to be elongate along the central axis d1 (not shown).

Note that the container accommodating portions 30a to 30d basically have a common configuration. Thus, here, the container accommodating portion 30d alone will be described. For the container accommodating portions 30a to 30c, the same reference signs are used as for the container accommodating portion 30d and no overlapping description will be repeated.

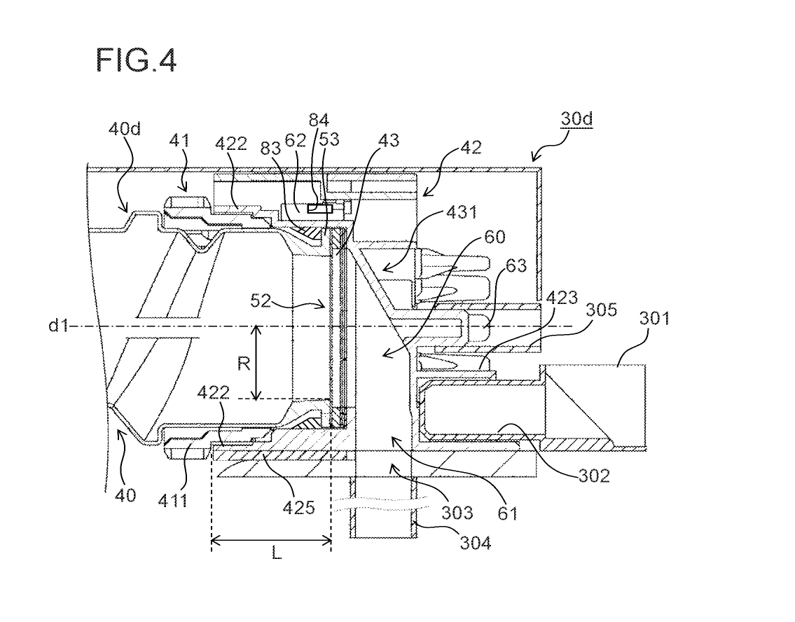

FIG. 4 is a sectional view of a downstream end part, along the axial direction, of the toner container 4d in a state accommodated in the container accommodating portion 30d, as cut along the axial direction. As shown in FIG. 4, the container accommodating portion 30d is provided with a toner supply port 303, an accommodation-side shutter 301, and an accommodation-side restricting portion 305. The same applies to the container accommodating portions 30a to 30c.

The toner supply port 303 is an opening formed in a lower part of the container accommodating portion 30d, downstream in the insertion direction. The toner supply port 303 communicates with the inside (not shown) of the developing device 3d via a supplying tube 304 extending along the top-bottom direction.

The accommodation-side shutter 301 can move between a closed position and an open position. The closed position is a position in which the toner supply port 303 is kept closed to inhibit communication with the inside of the developing device 3d. The open position is a position in which the toner supply port 303 is kept open to allow communication with the inside of the developing device 3d (i.e., the state shown in FIG. 4).

The accommodation-side shutter 301 has a boss 302 formed on it. The boss 302 extends along the insertion direction. The accommodation-side shutter 301 moves from the closed position to the open position as the boss 302 is pressed in the insertion direction.

With the toner container 4d accommodated in the container accommodating portion 30d, the accommodation-side restricting portion 305 is retracted along the insertion direction from a face opposite the toner container 4d. The accommodation-side restricting portion 305 can be a through hole with no bottom, or can be a depressed portion with a bottom.

### 3.3 Toner Containers 4a to 4d

The toner containers 4a to 4d store yellow, cyan, magenta, and black toner respectively in this order. When the proportions of the toner in the two-component developer loaded in the developing devices 3a to 3d fall below a prescribed value, the toner containers 4a to 4d supply toner to the developing devices 3a to 3d.

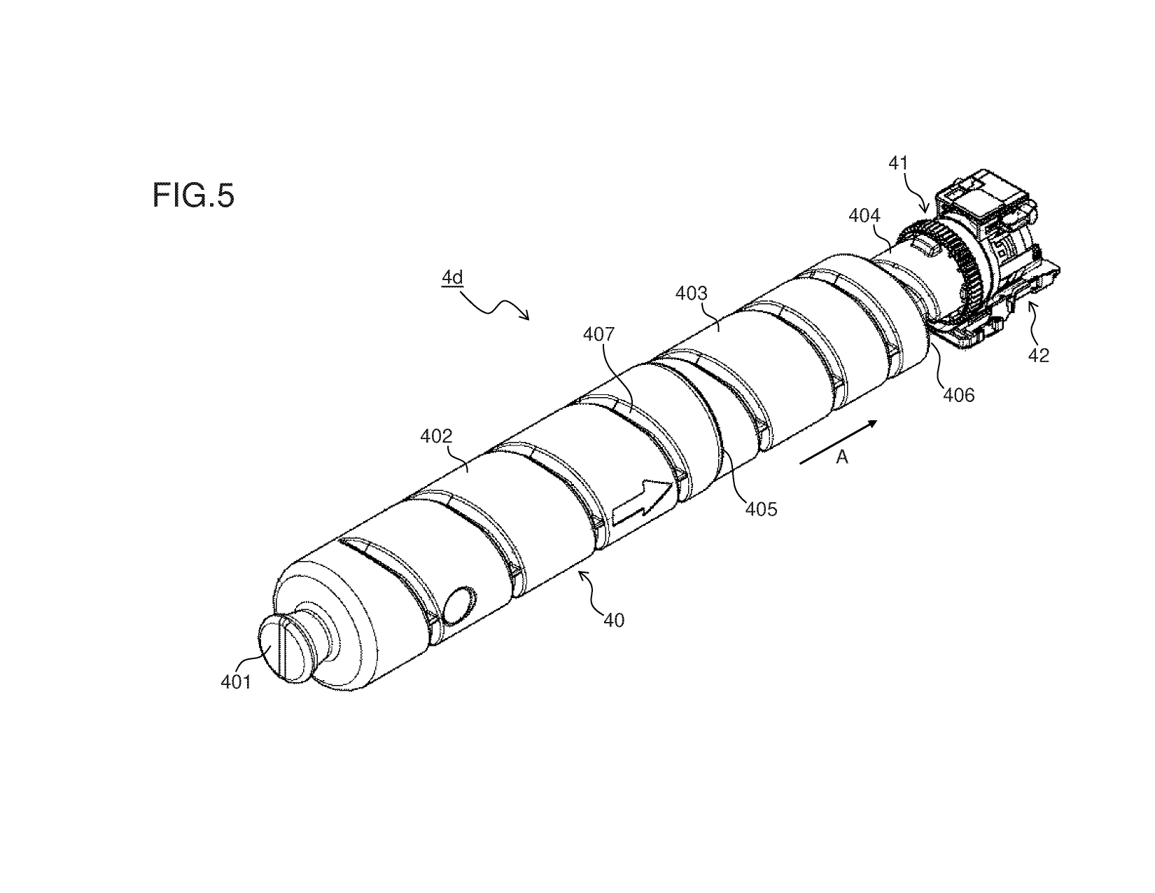

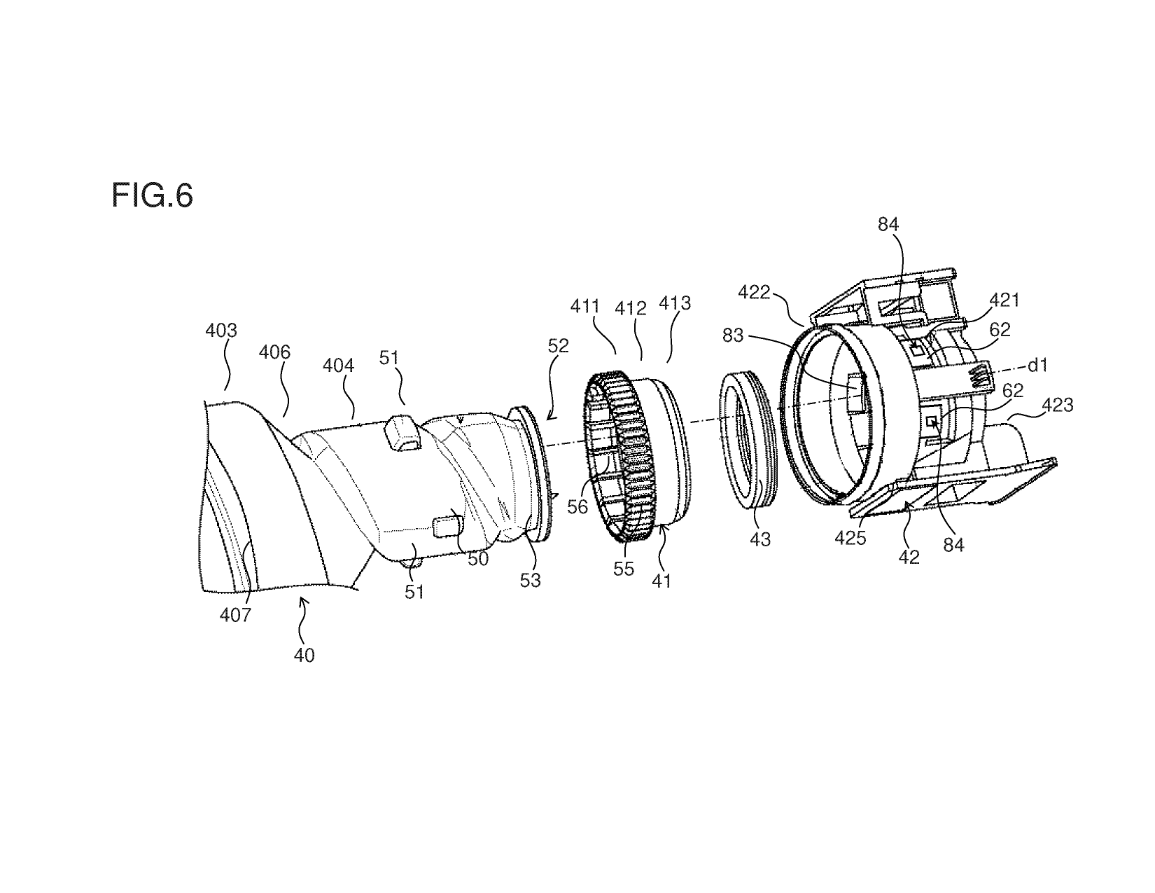

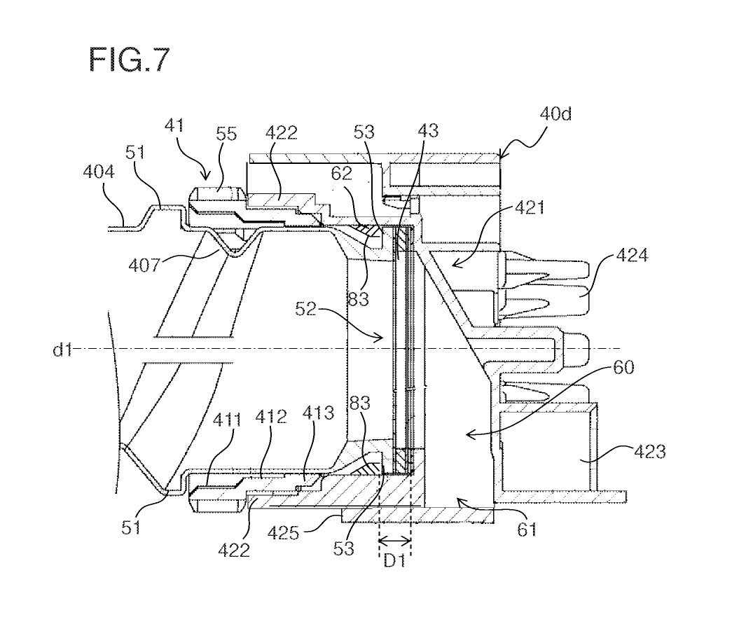

FIG. 5 is a perspective view of the toner container 4d according to the embodiment as viewed from its upstream side in the insertion direction. FIG. 6 is an exploded perspective view of a downstream (far right in FIG. 4) end part, in the insertion direction, of the toner container 4d according to the embodiment. FIG. 7 is a sectional view of a downstream end part, in the insertion direction, of the toner container 4d according to the embodiment as cut along the axial direction. While the following description focuses on the toner container 4d storing black toner, since the toner containers 4a to 4c storing yellow, cyan, and magenta toner have a similar configuration, the same reference signs are used and no overlapping description will be repeated.

As shown in FIGS. 5 to 7, the toner container 4d includes a container body 40, a transmission gear 41, a cap member 42, and a seal member 43.

The container body 40 is in a cylindrical shape that extends with its longitudinal direction aligned with the central axis d1 direction. The container body 40 stores toner in it. The container body 40 has an opening portion 52 formed at one end along the axial direction (more specifically, in an end part toward the rear of the image forming apparatus 100). The outer circumferential surface of the container body 40 is formed in a screw shape. As the container body 40 rotates about the central axis d1 along the circumferential direction, the toner stored in the container body 40 is conveyed by this screw shape toward the opening portion 52 along the central axis d1 (more specifically, from the front to the rear of the image forming apparatus 100). The detailed configuration of the container body 40 will be described below.

The container body 40 has a handle portion 401, a large-diameter tube portion 402, a medium-diameter tube portion 403, and a small-diameter tube portion 404.

The handle portion 401 is provided on an upstream end part of the container body 40 in the axial direction. The space inside the handle portion 401 communicates with the space inside the large-diameter tube portion 402. The large-, medium-, and small-diameter tube portions 402, 403, and 404 are formed in a cylindrical shape about the central axis d1. The medium-diameter tube portion 403 is provided between the large- and small-diameter tube portions 402 and 404. The outer diameter of the medium-diameter tube portion 403 is smaller than the large-diameter tube portion 402 but larger than the small-diameter tube portion 404.

The container body 40 has formed on its outer circumferential surface a first and a second step portion 405 and 406. The first step portion 405 is located between the large- and medium-diameter tube portions 402 and 403. The second step portion 406 is located between the medium- and small-diameter tube portions 403 and 404. The first and second step portions 405 and 406 are each in a spiral shape. The level difference of the first step portion 405 (the difference in the outer diameter between the large- and medium-diameter tube portions 402 and 403) is smaller than that of the second step portion 406 (the difference in outer diameter between the medium- and small-diameter tube portions 403 and 404).

The large-, medium-, and small-diameter tube portions 402, 403, and 404 of the container body 40 have formed on their inner circumferential surfaces continuously one conveyance rib 407 in a spiral shape so as to form the screw shape as mentioned above. The conveyance rib 407 protrudes from the inner circumferential surface of the container body 40 radially inward substantially in a V-shape as seen in a sectional view.

The small-diameter tube portion 404 is provided with a pair of first engaging protrusions 50 on its outer circumferential surface. One of the pair of first engaging protrusions 50 is disposed so as not to overlap with the conveyance rib 407. The other of the pair of first engaging protrusions 50 is disposed so as to overlap with the conveyance rib 407. The pair of first engaging protrusions 50 are provided at point-symmetric positions with respect to the central axis d1.

The small-diameter tube portion 404 is provided with a pair of second engaging protrusions 51 on its outer circumferential surface. The second engaging protrusions 51 are disposed such that neither of them overlaps with the conveyance rib 407. The second engaging protrusions 51 are disposed at positions 90 degrees displaced from the first engaging protrusions 50 respectively. That is, the pair of first engaging protrusions 50 and the pair of second engaging protrusions 51 are disposed such that their positions along the circumferential direction do not overlap with each other.

The small-diameter tube portion 404 is provided with the opening portion 52 as described above in a downstream end part of it in the axial direction. The opening portion 52 has a circular shape as seen from above. The opening portion 52 is provided in a circumferential part of it with a flange portion 53 in a ring form protruding radially outward.

The transmission gear 41 is attached to the outer circumferential surface of the small-diameter tube portion 404 of the container body 40. The transmission gear 41 is formed in a cylindrical shape about the central axis d1. The transmission gear 41 has a large-diameter part 411, a medium-diameter part 412, and a small-diameter part 413. The medium-diameter part 412 is provided downstream of the large-diameter part 411 with respect to the toner conveyance direction. The small-diameter part 413 is provided downstream of the medium-diameter part 412. In the transmission gear 41, the large-, medium-, and small-diameter parts 411, 412, and 413 have increasingly small diameters in this order.

The large-diameter part 411 is provided with gear teeth 55 on its outer circumferential surface. The diameter of the large-diameter part 411 including the gear teeth 55 is smaller than the outer diameters of either of the large- and medium-diameter tube portions 402 and 403 of the container body 40 but larger than the outer diameter of the small-diameter tube portion 404. An upstream end part of the large-diameter part 411 in the axial direction faces the second engaging protrusion 51 in the container body 40.

The transmission gear 41 is provided with a plurality of engaging ribs 56 extending along the axial direction across the entire region of the inner circumferential surface of the large- and medium-diameter parts 411 and 412. The plurality of engaging ribs 56 are provided at predetermined intervals along the circumferential direction (e.g. 10 to 20 of them are provided at equal intervals).

Between two pairs of engaging ribs 56 of the plurality of engaging ribs 56, one pair of first engaging protrusions 50 are inserted. This restricts the rotation of the transmission gear 41 with respect to the container body 40. The engaging ribs 56 except the two pairs of engaging ribs 56 mentioned above (the engaging ribs 56 between which no first engaging protrusion 50 is inserted) function as a reinforcing portion that reinforces the transmission gear 41.

The cap member 42 is attached to the container body 40 so as to cover the opening portion 52 of the container body 40. The cap member 42 has a body portion 421, a holding portion 422, an engaging tube portion 423, a cover-side restricting portion 424, and a cover-side shutter 425.

Inside the body portion 421, a communicating portion 60 is provided. The communicating portion 60 communicates with the toner storing space in the container body 40 via the opening portion 52 of the container body 40. At the lower end of the communicating portion 60, a toner discharge port 61 is provided.

The holding portion 422 extends from the body portion 421 upward in the insertion direction. More specifically, the holding portion 422 is substantially in a cylindrical shape about the central axis d1 protruding from the body portion 421 toward the container body 40.

The inner circumferential surface of the holding portion 422 faces the outer circumferential surfaces of the medium- and small-diameter parts 412 and 413 of the transmission gear 41. The holding portion 422 of the cap member 42 is, on its inner circumferential surface, provided with a total of four hook portions 62.

In a state where the flange portion 53 (a downstream end part in the axial direction) of the container body 40 and the seal member 43 are held in a the gap D1 between the hook portions 62 and the body portion 421, the hook portions 62 engage with the flange portion 53. The gap D1 is smaller than the total thickness of the flange portion 53 and the seal member 43. Thus, the seal member 43 is compressed to a predetermined thickness. This helps maintain the seal between the container body 40 and the cap member 42. The configuration of the hook portion 62 will be described in detail later.

Between the holding portion 422 and the second engaging protrusion 51 of the container body 40, the transmission gear 41 is held. This restricts the movement of the transmission gear 41 along the axial direction with respect to the container body 40. This also prevents the transmission gear 41 from slipping off the container body 40.

The engaging tube portion 423 is a tubular protrusion that protrudes from the body portion 421 downstream in the insertion direction. The engaging tube portion 423 has the boss 302 inserted in it to fit around the boss 302.

The cover-side restricting portion 424 is provided with a fitting protrusion 63. The fitting protrusion 63 is a protrusion that protrudes away from the container body 40 along the axial direction. With the toner container 4d accommodated in the container accommodating portion 30d, the fitting protrusion 63 is inserted into the accommodation-side restricting portion 305 to fit in the accommodation-side restricting portion 305. Fitting the fitting protrusion 63 in the accommodation-side restricting portion 305 permits the toner container 4d to be positioned with respect to the container accommodating portion 30d.

The cover-side shutter 425 can move between a closed position and an open position. The open position is a position in which the cover-side shutter 425 keeps the toner discharge port 61 open. The closed position is a position to which the cover-side shutter 425 moves to close the toner discharge port 61.

The seal member 43 is formed in a ring shape. The seal member 43 is disposed radially inward of the holding portion 422 in the cap member 42. The seal member 43 is disposed in a compressed state between the flange portion 53 and the body portion 421. The seal member 43 is fixed to a face (an upstream face along the axial direction) of the body portion 421 opposite the flange portion 53.

The seal member 43 is configured as a plurality of (e.g., four) layers formed by stacking together a plurality of sheets. The topmost layer of the container body 40 toward the flange portion 53 is formed of an elastic material (e.g., urethane foam).

### 3.4 Accommodating Operation for Toner Containers 4a to 4d

The toner containers 4a to 4d share similar accommodating operation. Thus, here, only the operation for accommodating the toner container 4d into the container accommodating portion 30d will be described. For the operation for accommodating the toner containers 4a to 4c into the container accommodating portions 30a to 30c, no overlapping description will be repeated.

As shown in FIG. 3, the toner container 4d is inserted into the container accommodating portion 30d starting with an end part of it along the axial direction where it has the cap member 42.

As shown in FIG. 4, when the toner container 4d is inserted in the container accommodating portion 30d, the engaging tube portion 423 engages with the boss 302. In this state, the boss 302 is pressed by the body portion 421. Then, the accommodation-side shutter 301 moves from the closed position to the open position. This opens the toner supply port 303 in the container accommodating portion 30d.

Moreover, when the toner container 4d is inserted in the container accommodating portion 30d, the cover-side shutter 425 moves from the closed position to the open position. This opens the toner discharge port 61 in the body portion 421 of the cap member 42. In this way, the communicating portion 60 communicates with the supplying tube 304.

At the same time, the fitting protrusion 63 fits in the accommodation-side restricting portion 305 in the container accommodating portion 30d. This positions the toner container 4d with respect to the container accommodating portion 30d. In this way, the toner container 4d becomes accommodated in the container accommodating portion 30d.

### 3.5 TONER SUPPLYING OPERATION

The toner containers 4a to 4c share similar toner supplying operation. Thus, here, only the operation for supplying toner from the toner container 4d to the developing device 3d will be described. For the operation for supplying toner from the toner containers 4a to 4c to the developing devices 3a to 3c, no overlapping description will be repeated.

As shown in FIG. 4, with the toner container 4d accommodated in the container accommodating portion 30d, the toner supply motor (not shown) is driven. Then, the rotational driving force of the toner supply motor is transmitted via a gear train and a drive input gear (neither is shown) to the transmission gear 41 of the toner container 4d. This rotates the transmission gear 41.

As the transmission gear 41 rotates, the container body 40 rotates together with it. In this way, the rotational driving force from the toner supply motor is transmitted to the container body 40.

On the other hand, the cap member 42 and the seal member 43 do not rotate even when the container body 40 rotates and stay stationary. Thus, the container body 40 rotates relative to the cap member 42 and the seal member 43.

As the container body 40 rotates, the conveyance rib 407 of the container body 40 conveys the toner in the container body 40 from upstream to downstream in the toner conveyance direction. The toner is then discharged via the opening portion 52 out of the container body 40. The toner discharged out of the container body 40 is led into the communicating portion 60. The toner led into the communicating portion 60 is discharged via the toner discharge port 61 out of the communicating portion 60. The toner discharged out of the communicating portion 60 is led into the supplying tube 304 via the toner supply port 303. The toner is then supplied from the supplying tube 304 to the developing device 3d.

### 4.1 Detailed Configurations of Flange Portion 53 and Hook Portion 62

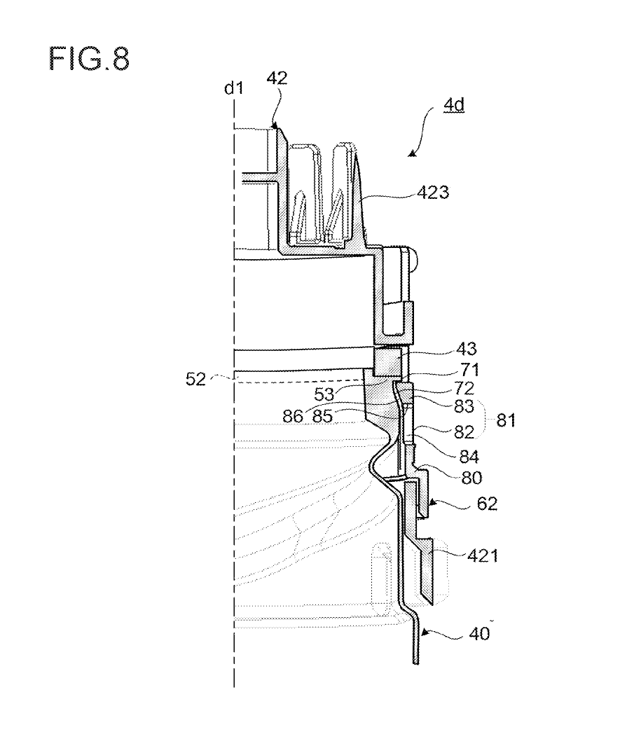

Next, the configurations of the flange portion 53 and the hook portion 62 according to the embodiment will be described in detail. Note that, unless otherwise stated, basically, the configurations of the flange portion 53 and the hook portion 62 with the cap member 42 attached to the container body 40 (the state in FIG. 8) will be described.

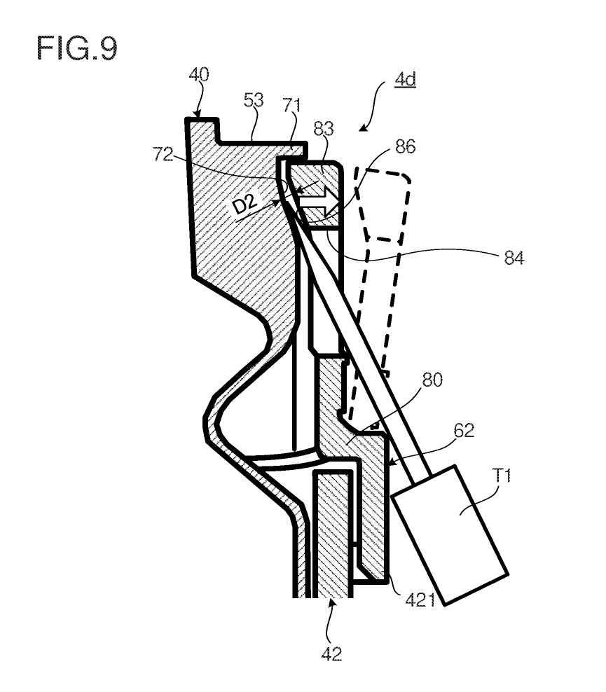

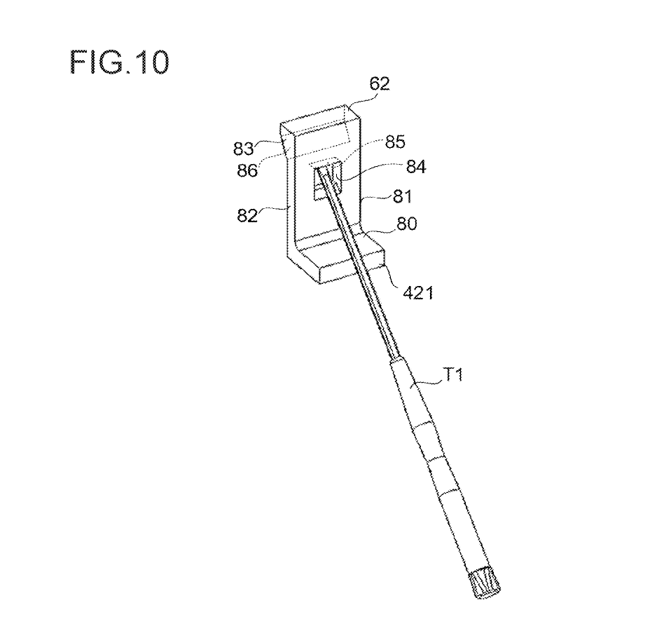

FIG. 8 is a sectional view of the toner container 4d, showing a state where the hook portion 62 and the flange portion 53 are engaged together. FIG. 9 is an enlarged sectional view around the hook portion 62 and the flange portion 53 shown in FIG. 8. FIG. 10 is a perspective view of the hook portion 62.

As shown in FIGS. 8 and 9, the flange portion 53 has a protruding part 71 and an opposing face 72. The protruding part 71 is formed in an upstream end part of the container body 40 along the insertion direction, around the circumference of the opening portion 52. The protruding part 71 protrudes from the outer circumferential surface of the container body 40 radially outward of the container body 40.

The opposing face 72 is part of the outer circumferential surface of the container body 40 downstream of the protruding part 71 (opposite from the opening portion 52 of the container body 40) in the insertion direction. The opposing face 72 is a tapered face formed such that the container body 40 has an increasingly small outer diameter from upstream to downstream in the insertion direction of the container body 40. In other words, the opposing face 72 has a face that radially inclines toward the central axis d1 of the container body 40 from upstream to downstream in the insertion direction.

As shown in FIGS. 8 to 10, the hook portion 62 has a base part 80 and an arm part 81. The base part 80 is a part of the cap member 42 that is continuous with the body portion 421 and that is located at the boundary between the hook portion 62 and the body portion 421.

The arm part 81 extends in a straight line along the axial direction from the base part 80. More specifically, it is configured as follows. The arm part 81 has a straight part 82 and a claw part 83.

The straight part 82 is formed so as to extend in a straight line along the axial direction (more specifically, parallel to the axial direction) from the base part 80 toward the engaging tube portion 423. The straight part 82 can elastically deform radially such that the tip (the claw part 83) pivots about the base part 80.

The straight part 82 has an operation hole 84 formed in it. The operation hole 84 is a through hole that radially penetrates the straight part 82. The operation hole 84 is in a rectangular shape as seen in a radial plan view. The operation hole 84 has a first operation face 85 (one example of a first face) formed on it. The first operation face 85 is a downstream face (an upper face in FIGS. 8 and 10) of the four inner side faces of the operation hole 84 in the insertion direction.

The first operation face 85 is a flat face extending parallel to the radial direction. The first operation face 85 faces the base part 80 along the axial direction.

The claw part 83 is formed at the tip of the straight part 82. The claw part 83 is located downstream of the operation hole 84 in the insertion direction. The claw part 83 is located upstream of the protruding part 71 in the insertion direction. The first operation face 85 can be understood as the lower face of the claw part 83. The claw part 83 protrudes radially inward from an radially inner face of the straight part 82.

The claw part 83 has a second operation face 86 (one example of a second face) formed on it. The second operation face 86 is connected to a radially inner edge part of the first operation face 85. The second operation face 86 radially faces the opposing face 72. The second operation face 86 is a tapered face that inclines so as to be parallel to the opposing face 72. That is, the second operation face 86 inclines radially inward from a part of it connecting to the first operation face 85 upstream in the insertion direction (toward the engaging tube portion 423).

A gap D2 is left between the second operation face 86 and the opposing face 72 (see FIG. 9). The gap D2 communicates with the space inside the operation hole 84 and hence with the space outside the cap member 42. In other words, the gap D2 leads to the space outside the cap member 42 via the operation hole 84.

The hook portion 62 is formed so as to be elastically deformable from a restricting posture (the posture indicated by solid lines in FIG. 9) to a non-restricting posture (the posture indicated by broken lines in FIG. 9). The restricting posture is a posture of the hook portion 62 in which the claw part 83 axially faces the protruding part 71.

The hook portion 62 is in the restricting posture with no external force acting on it (in a state where the cap member 42 is accommodated in the container body 40). With the hook portion 62 in the restricting posture, when the cap member 42 tends to move away from the container body 40 upstream in the insertion direction, the claw part 83 makes contact with the protruding part 71. This restricts the movement of the hook portion 62 (hence the cap member 42) upstream in the insertion direction.

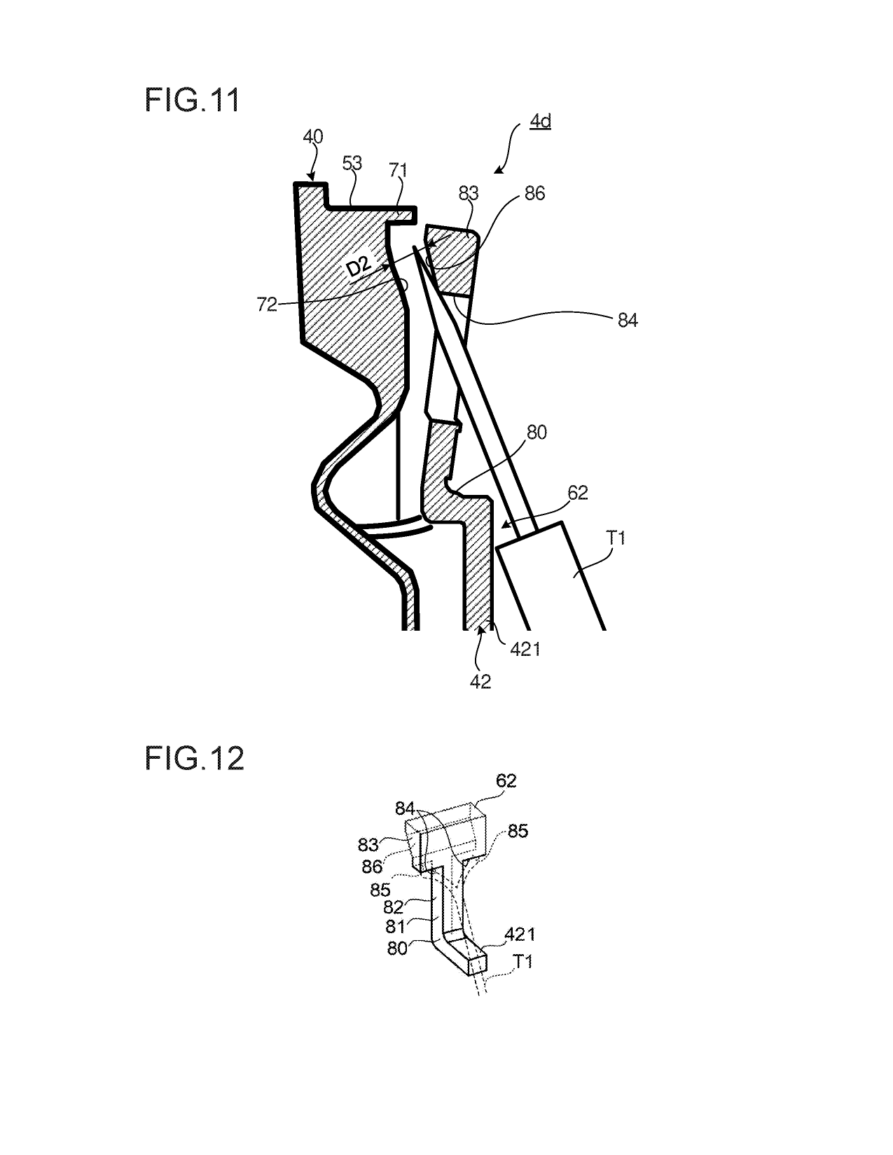

FIG. 11 is an enlarged sectional part view of the cap member 42, showing a state where the hook portion 62 is in the non-restricting posture. As shown in FIG. 11, the non-restricting posture is a posture in which the hook portion 62 has elastically deformed from the restricting posture radially outward under an external force.

When the hook portion 62 is in the non-restricting posture, the claw part 83 is retracted to a position where it does not face the protruding part 71 along the axial direction. Thus, when the cap member 42 tends to move away from the container body 40 upstream in the insertion direction with the hook portion 62 in the non-restricting posture, the claw part 83 stays away from the protruding part 71. That is, the movement of the hook portion 62 (hence the cap member 42) upstream in the insertion direction is not restricted. Thus, when the cap member 42 is detached from the container body 40, first the hook portion 62 is elastically deformed from the restricting posture to the non-restricting posture and then the cap member 42 is pulled out upstream in the insertion direction. A more detailed description will be given below.

### 4.2 Operation for Detaching Cap Member 42

As described above, the cap member 42 is attached to the container body 40. That is, the hook portion 62 is in the restricting posture. An operator can use a tool T1 with a flat tip (e.g., a flat-blade screwdriver or a special jig with a shape similar to a flat-bladed screwdriver; hereinafter referred to simply as tool). Then, the operator inserts the tip of the tool T1 into the operation hole 84.

Here, as described above, the gap D2 communicates with the space outside the cap member 42 via the operation hole 84. In other words, the gap D2 can be reached from outside the cap member 42 via the operation hole 84. Thus, the operator inserts the tip of the tool T1 into the gap D2 via the operation hole 84 (see FIG. 9).

In this state, the operator moves the tip of the tool T1 radially outward to press the second operation face 86 with the tip of the tool. Meanwhile the second operation face 86 is acted on by a radially outward stress from the tip of the tool T1 (see the hollow arrow in FIG. 9). Then, the claw part 83 moves radially outward such that the straight part 82 bends (elastically deforms) outward.

The claw part 83 moves to a position where it no longer faces the protruding part 71 along the axial direction, so that the hook portion 62 moves from the restricting posture to the non-restricting posture (see FIG. 11). In this state, the operator pulls out the cap member 42 downstream in the insertion direction as described above. In this way, the cap member 42 is detached from the container body 40.

### 5.1 Study

Now, a comparative example with no feature comparable with the operation hole 84 will be studied. With such a configuration, it is difficult to reach the gap D2 from outside the cap member 42 and to directly press the second operation face 86. Such a comparative example requires sticking a flat stick, the nail of a finger of the operator, or the like into the side part of the hook portion 62 (more specifically, the arm part 81) to elastically deform it. Then, the direction of the stress acting on the hook portion 62 may not coincide with the direction in which the hook portion 62 needs to be elastically deformed (i.e., the radially outward direction in which the hook portion 62 moves from the restricting posture to the non-restricting posture). This may result in putting a heavy load on the hook portion 62, such as an excessive force not intended by design acting on the hook portion 62, or concentrated stress at a spot not intended. Such a load may damage (as by plastically deforming, or breaking) the hook portion 62.

On the other hand, the hook portion 62 according to the embodiment of the present disclosure has the operation hole 84 formed in it as described above. Thus, it is possible to reach the gap D2 from outside the cap member 42. With the tool T1 inserted into the operation hole 84, the second operation face 86 can be directly pressed to elastically deform the hook portion 62. That is, with the tool T1, a pressing force can be applied to the hook portion 62 in such a direction as to elastically deform it. Thus, it is possible to suppress a load that acts on the hook portion 62 and thus to avoid damage to the hook portion 62.

### 5.2 Modified Example

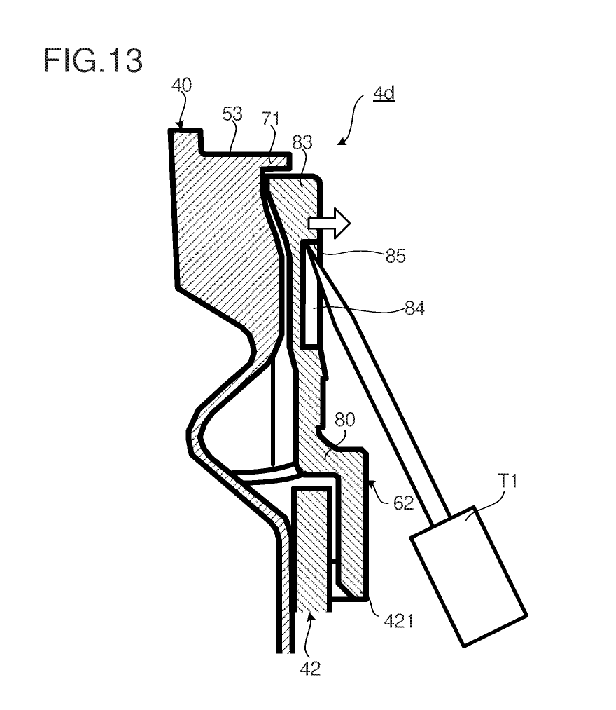

The present disclosure is not limited to the embodiment described above, and thus any modification can be made without departing from the spirit of the present disclosure. For example, as shown in FIG. 12, the hook portion 62 can be formed in a T-shape. In that case, the operation hole 84 is provided one at each side of the straight part 82. In addition, in that case, it is possible to use a dedicated tool T1 with a bifurcated tip as indicated by broken lines in the diagram.

In addition, while the operation hole 84 is described above to be a through hole above, it can be a non-penetrating recessed part as shown in FIG. 13. In that case, the tip of the tool T1 is brought into contact with the first operation face 85 to apply a radially outward stress to the hook portion 62 by friction between the first operation face 85 and the tip of the tool T1. This can elastically deform the hook portion 62 from the restricting posture to the non-restricting posture.

While the above embodiment deals with the toner containers 4a to 4d that are incorporated in the image forming apparatus 100 incorporating the developing devices 3a to 3d of a two-component development method using two-component developer containing magnetic carrier and toner and that store toner for supply to the developing devices 3a to 3d, the present disclosure is equally applicable to toner containers that store toner for supply to developing devices of a magnetic one-component development method using magnetic toner or of a non-magnetic one-component development method using non-magnetic toner.

In the above embodiment, the seal member 43 is fixed to the body portion 421 in the cap member 42. Instead, it can be configured as follows. For example, the seal member 43 can be fixed to the flange portion 53 of the container body 40. Note that, if the seal member 43 is fixed to the flange portion 53, when the cap member 42 is attached to the container body 40, the seal member 43 may make contact with the holding portion 422 to be damaged. Thus, in view of easy assembly of the toner container 4d, preferably, the seal member 43 is fixed to the cap member 42.

The present disclosure finds applications not only in tandem color printers as shown in FIG. 1 but also in any image forming apparatuses using toner containers, such as color copiers and color multifunction peripherals, monochrome printers and monochrome copiers, and monochrome multifunction peripherals.

What is claimed is:

1. A toner storage container comprising:
a container body that stores toner therein, the container body having an opening portion formed at one end thereof along an axial direction along a central axis thereof, the container body being in a cylindrical shape; and
a cap member that is attached to one end of the container body along the axial direction so as to cover the opening portion, the cap member being detachable in the axial direction with respect to the container body,
wherein
the container body has a protruding part that protrudes radially outward with respect to the container body from an outer circumferential surface of the container body,
the cap member has a hook portion that, with the cap member attached to the container body, is in a restricting posture in which the hook portion makes contact with the protruding part along the axial direction to restrict movement of the cap member along the axial direction and that, by elastically deforming radially outward from the restricting posture, takes a non-restricting posture in which the hook portion does not restrict the movement of the cap member along the axial direction,
the hook portion has:
a base part; and
an arm part extending in a straight line along the axial direction from the base part, the arm part having a tip facing the protruding part along the axial direction in the restricting posture, the arm part elastically deforming such that the tip is retracted radially outward so as not to face the protruding part along the axial direction in the non-restricting posture, and
the hook portion has an operation hole formed therein extending radially inward from a radially outer face of the hook portion.

2. The toner storage container according to claim 1, wherein
the operation hole is a through hole that penetrates radially from a radially outer face of the arm part to an inner face thereof.

3. The toner storage container according to claim 2, wherein
the hook portion includes:
a first face that is at least part of an inner circumferential face of the operation hole and that faces the base part; and
a second face that is connected to the first face and that radially faces the container body, and
a gap between the container body and the second face leads to a space outside the cap member via the operation hole.

4. The toner storage container according to claim 3, wherein
the second face inclines radially toward the container body while extending from an edge part of the second face at a border thereof with the first face toward the protruding part along the axial direction, and
the container body has an opposing face that faces the second face across the gap and that is parallel to the second face.

5. The toner storage container according to claim 1, wherein
the operation hole is formed at least one at each side of the container body with the arm part in between along a circumferential direction of the container body perpendicular to both the axial direction and a radial direction thereof.

6. The toner storage container according to claim 1, wherein
the operation hole is a depressed part with a bottom that is depressed radially inward from outer face of the hook portion, and
the operation hole has an operation face that is disposed at a predetermined interval from an edge of an opening of the operation hole toward the base part and that faces the bottom.
